(19) United States
(12) Patent Application Publication
(10) Pub. No.: US 2006/0082762 A1
(43) Pub. Date: Apr. 20, 2006

(54) Automated polarized light microscope combined with a spectroscopy/spectral imaging apparatus

(76) Inventors: Chad Leverette, Arlington, TN (US); Sean A Smith, Memphis, TN (US)

Correspondence Address: CARGILL, INCORPORATED, LAW/24, 15407 MCGINTY ROAD WEST, WAYZATA, MN, 55391, US

(21) Appl. No.: 10/549,980

(22) PCT Filed: Feb. 12, 2004
(86) PCT No.: PCT/US04/04082

§ 371 Date: Sep. 20, 2005

Related U.S. Application Data
(60) Provisional application No. 60/457,615, filed on Mar. 26, 2003.

(51) Int. Cl. G01J 3/00; G01J 3/44; G01N 21/00

(52) U.S. Cl. 356/72; 356/301; 356/300

(57) ABSTRACT

There is disclosed a device or apparatus that is particularly suitable for use in the analytical fields of polarized light microscopy and spectroscopy/spectral imaging. The apparatus comprises an automated polarized light microscope combined with means for achieving spectroscopic analysis. The apparatus may optionally include means for spectral imaging associated with the means for achieving spectroscopic analysis. Any means for achieving spectroscopic analysis may be utilized for example Raman, mid-infrared, near-infrared, ultraviolet, visible, luminescence, and the like.

This application claims priority of Provisional Application Ser. No. 60/457,615 filed Mar. 26, 2003, the entire contents of which are incorporated herein by reference.

### FIELD OF THE INVENTION

This invention relates to a device or apparatus that is particularly suitable for use in the analytical fields of polarized light microscopy and spectroscopy/spectral imaging.

### BACKGROUND OF THE INVENTION

Polarized Light Microscopy (PLM) is an established imaging technique that has existed for several decades. Polarized light microscopy has been employed in numerous scientific arenas including biology, chemistry, mineralogy, metallography, and forensic studies. In biology and chemistry, polarized light microscopy has the unique ability to monitor non-destructively in transmission or reflection mode the submicroscopic molecular structural organization of samples in their native environmental state. The contrast enhancement obtained from polarized light microscopy results from the inherently high degree of order possessed by living tissue or structured material on a molecular level. This ordered arrangement of the molecules of interest causes the tissue to be birefringent, that is it impedes certain polarizations of light more than others. The native birefringence of a sample is unique to that sample and serves as the foundation of the theory behind polarized light microscopy technology. The majority of polarized light microscopy work has been performed by forensic and biological scientists, who took advantage of the increased contrast provided by polarized light microscopy relative to white light microscopy for in situ observations of living tissue. The primary drawback to polarized light microscopy technology is that the single images collected display the birefringence retardation of only the anisotropic structures that are oriented properly with respect to the polarization axes of the microscope. This initial display of birefringence retardation is represented by intensity on the camera used in a polarized light microscope and does not provide a value of retardance for this orientation. For a traditional polarized light microscope to provide quantitative images of retardance, retardance must be calculated for each orientation of the sample. This is extremely time consuming during an experiment and would not offer an advantage as a quantitative screening technique for chemical difference in an image. In addition, obtaining quantitative retardance images for all anisotropic structures arranged in all orientations for the same sample is extremely difficult and time consuming. This limitation of a traditional polarized light microscope usually results in the measurement of birefringence retardation only at selected points or in areas of uniform birefringence.

A new technology engineered to overcome the limitations of traditional polarized light microscopy is known as the LC-PolScope™ IM Automated Polarized Light Microscope (available from Cambridge Research and Instrumentation, Cambridge, Mass.). This technology represents a new optical arrangement of polarized light microscopy. The new LC-PolScope IM automated polarized light microscope incorporates a precision universal compensator made of two liquid crystal variable retarders that are computer controlled. These two retarders replace the traditional compensator of the polarizing microscope. The result of these changes is a polarized light microscope that can produce fast measurements of specimen anisotropy at all points in the field of view of a given image regardless of the birefringence axis. These rapid measurements of native birefringence can be directly interpreted in terms of submicroscopic order for a given sample. The images recorded with the LC-PolScope IM automated polarized light microscope provide the magnitude of the specimen birefringence (displayed as retardance, which is the birefringence multiplied by the penetration depth stated in nanometers) independent of axis orientation as well as the orientation of the birefringence axis (polarization azimuth) at each image point. Therefore, retardance values for all anisotropic structures regardless of orientation are acquired simultaneously, vastly improving the speed of usefulness of this technique. The LC-PolScope IM automated polarized light microscope greatly enhances the power and potential of this technique.

Spectroscopy is a well-known area of science that deals with the interaction of electromagnetic radiation with matter. These interactions with the energy states of chemical species include the absorption, emission, and scattering of radiation.. These interactions are displayed in a graph called a spectrum. A spectrum is any display of the intensity of the radiation emitted, absorbed, or scattered by the sample versus a measure of the energy of the radiation. From the information provided in a spectrum, details concerning the structure, function, and amount of a chemical species can be determined.

Spectroscopic or spectrochemical analysis involves the use of spectroscopy to qualitatively and quantitatively characterize any given chemical species. In general, spectroscopic analysis covers the electromagnetic range from audio frequencies, less than 20 kHz (kilohertz) to gamma rays, greater than 10¹⁹ Hz (Hertz). More specifically, microscope based spectroscopic techniques are most suitable in the optical electromagnetic range. This optical range spans from the Ultraviolet (UV) (approximately 10¹⁵ Hz or approximately 10 nm (nanometers)) through the Infrared (IR) (approximately 10¹² Hz or approximately 50 μm (micrometers)).

Optical spectroscopic analysis is usually divided into two groups: atomic and molecular. Atomic spectroscopy usually involves the analysis of free atomic species in the vapor state. Molecular spectroscopy involves the analysis of molecular species in the solid, liquid, or gas state.

The prior art has disadvantages such that it would be desirable to have a suitable device that combines the fields of automated polarized light microscopy and spectroscopy, with or without spectral imaging. This device would provide desirable results such as for example more efficient data acquisition and more detailed chemical information for a given sample.

### SUMMARY OF THE INVENTION

The present invention relates to an apparatus comprising an automated polarized light microscope combined with any means for achieving spectroscopic analysis that may also include the use of a microscope. In another embodiment of the present invention, it is desirable that the means for achieving spectroscopic analysis have means for spectral imaging. Furthermore, the spectroscopic means may be any spectroscopic means such as Raman, mid-infrared, near-infrared, ultraviolet, visible, and luminescence.

### DETAILED DESCRIPTION OF THE INVENTION

The present invention relates to an apparatus comprising an automated polarized light microscope combined with any means for achieving spectroscopic analysis that may also include the use of a microscope. In another embodiment of the present invention, it is desirable that the means for achieving spectroscopic analysis have means for spectral imaging. Furthermore, the spectroscopic means may be any spectroscopic means such as Raman, mid-infrared, near-infrared, ultraviolet, visible, and luminescence.

In producing the apparatus of the present invention, there is utilized an automated polarized light microscope. An automated polarized light microscope has an optical configuration similar to a traditional cross polarizers light microscope. An automated polarized light microscope comprises a universal compensator also known as variable retarders, at least one appropriate filter, at least one polarizer, at least one image acquisition device, and computer software to perform the calculations such as retardance and to control the apparatus. The universal compensator replaces the traditional compensator in a polarized light microscope. The universal compensator is composed of variable retarders that can enhance the optical path difference present from the light rays exiting the anisotropic sample. This facilitates the calculation of the retardance for a given orientation. A filter is a device that can pass a discrete, selected region of electromagnetic radiation in an attempt to allow only desired radiation to pass. A polarizer is an optical element that is made of specialized materials that restricts the electric vectors of radiation to a single plane by filtration of the beam. Radiation can be circularly, elliptically, or linearly (plane) polarized. A typical image acquisition device is a sensitive charge coupled device detector array capable of forming an image. For instance, most cameras are composed of charge coupled device technology. The software needed to perform the calculations would contain the algorithms needed to calculate the retardance for each image pixel regardless of orientation and as a function of the variable retarder settings.

The automated polarized light microscope illuminates the sample. Preferably the sample is illuminated in either transmission or reflection mode.

In transmission mode, the radiation exits the light source and is directed by a mirror through the field iris diaphragm, the appropriate polarizer(s) and filter(s), and the condenser onto the sample stage. Here the polarized light transmits through the sample and is collected by the desired microscope objective. The polarized light then travels through the beam cube, then through the spectroscopy interface, and into the universal compensator, which determines and maximizes the optical path difference between the ordinary and extraordinary rays. The recombined rays are then transmitted to the image acquisition device.

In reflection mode, the light exits the light source and transmits through the aperture iris diaphragm, then the field iris diaphragm, and then through the appropriate polarizer(s) and filter(s). Once this transmitted light is polarized, the polarized light enters the beam cube where it is directed through the microscope objective and onto the sample. The sample reflects the polarized light back through the microscope objective on the same optical axis. The polarized light then travels through the beam cube, then through the spectroscopy interface, and then into the universal compensator, which determines and maximizes the optical path difference between the ordinary and extraordinary rays. The recombined rays are then transmitted to the image acquisition device.

A suitable example of an automated polarized light microscope is the LC-PolScope™ IM Automated Polarized Light Microscope available from Cambridge Research and Instrumentation, Cambridge, Mass. In this design, the white light from the microscope lamps is converted to monochromatic radiation with a wavelength of 546 nanometers. In addition, the light is passed through a circular polarizer producing circularly polarized monochromatic light that passes through the sample. The LC-PolScope IM automated polarized light microscope incorporates a precision universal compensator made of two liquid crystal variable retarders that are computer controlled. The polarization of the transmitted light is controlled by applying electrical voltages to the liquid crystal retarders. This applied voltage allows the LC retarders to switch between four predetermined polarization states of known elliptical and principal axis orientations thereby controlling the polarization of the transmitted light. During the switching process, a video camera records images for each of the polarization states. Once collected, polarimetric algorithms convert the raw images into images that represent the retardance of the specimen. The magnitude of the retardance, regardless of orientation, as well as the birefringence axis (polarization azimuth) is collected at each image point for all of the anisotropic structures of the specimen. Retardance is defined as the birefringence of a sample multiplied by its thickness in nanometers. Birefringence is equal to the difference in refractive index experienced by two orthogonally polarized light waves (i.e. ordinary and extraordinary rays) traveling through a specimen. The axis in the specimen where the birefringence is the greatest is referred to as the slow axis. The slow axis (i.e. polarization azimuth) corresponds to the orientation of the linear polarization of light that experiences the highest refractive index when passing through the specimen. The data is displayed in pseudocolor image called a retardance/rotation composite image. In this composite image, a 180° color wheel is used to display the retardance values and the orientation of the slow axis. The intensity of a given color is a direct measure of the retardance at that image point. For instance, the center of the wheel is black indicating values for retardance approximately equal to 0. If the color is white then the magnitude of the retardance approximates the maximum expected retardance (that is, MER=λ/2 where λ is the wavelength of light used for the experiment). Therefore, the scale of the retardance progresses from black to white for a given color. The type of color represents the direction of the polarization azimuth.

In producing the apparatus of the present invention, there is utilized in combination with the automated polarized light microscope, any means suitable for achieving spectroscopic analysis that may include a microscope. The means for achieving spectroscopic analysis may optionally include means for spectral imaging. Suitable means for achieving spectroscopic analysis and spectral imaging include at least one type of spectroscopic technique such as Raman, mid-infrared, near-infrared, ultraviolet, visible, luminescence, and the like.

Spectroscopy is a well-known area of science that deals with the interaction of electromagnetic radiation with matter. These interactions with the energy states of chemical species include the absorption, emission, and scattering of radiation. These interactions are displayed in a graph called a spectrum. A spectrum is any display of the intensity of the radiation emitted, absorbed, or scattered by the sample versus a measure of the energy of the radiation. From the information provided in a spectrum, details concerning the structure, function, and amount of a chemical species can be determined.

Spectroscopic analysis involves the use of spectroscopy to qualitatively and quantitatively characterize any given chemical species. In general, spectroscopic analysis covers the electromagnetic range from audio frequencies, less than 20 kHz to gamma rays, greater than 10¹⁹ Hz. More specifically, microscope based spectroscopic techniques are most suitable in the optical electromagnetic range. This optical electromagnetic range covers the region from the ultraviolet (UV) (approximately 10¹⁵ Hz) through the infrared (IR) (approximately 10¹² Hz). Electromagnetic radiation is also referred to as light.

Optical spectroscopic analysis is usually divided into two groups: atomic and molecular. Atomic spectroscopy usually involves the analysis of free atomic species in the vapor state. Molecular spectroscopy involves the analysis of molecular species in the solid, liquid, or gas state.

One area of molecular spectroscopy particularly well suited for the analysis of molecular species is vibrational spectroscopy. Vibrational spectroscopy monitors the interaction of electromagnetic radiation with the vibrations of the chemical bonds in a molecule of a chemical species. Typical of vibrational spectroscopic techniques are mid-infrared, near-infrared, and Raman. These techniques provide complimentary chemical information, but are based on different quantum mechanical selection rules. Other molecular spectroscopic techniques include for example ultraviolet, visible, and luminescence. More detailed descriptions of these spectroscopic techniques are provided herein.

Raman spectroscopy is one of the most versatile analytical techniques for chemical analysis. Raman spectroscopy is routinely performed in the visible portion of the electromagnetic spectrum (10¹⁵ Hz-10¹⁴ Hz or 180 nm-1000 nm). This vibrational technique can be used for routine qualitative and quantitative measurements of inorganic and organic chemical species that exist as gases, vapors, aerosols, liquids, or solids. Experiments can also be performed at room temperature and at cryogenic or high temperatures. Raman spectroscopy is utilized to solve complex analytical problems such as determining molecular structure and orientation. Raman spectroscopy is also extremely sensitive to the native molecular order of a sample. Due to the sensitivity of Raman to molecular order, structural conformation, as well as absolute molecular orientation, this technique is widely used in the fields of material and polymer science.

The sharp vibrational bands observed in a traditional Raman spectrum of a particular molecule are directly related to the specific chemical moieties present in that compound for example C—H, N—H, and the like. It is the presence, nature, or orientation of these moieties that give the overall molecule a specific chemical structure. If certain vibrational bands sensitive to crystallinity and orientation are identified and monitored throughout a Raman experiment, structural and conformational changes and properties can be observed and quantified for a given chemical compound. In addition, the absolute orientation of an ordered sample can also be determined through the acquisition of accurate Raman polarization measurements and careful mathematical calculations.

Raman spectroscopy is usually performed on one small region of a given sample. The use of a microscope together with Raman spectroscopy furthered the ability of these techniques to probe microscopic features of a given sample by focusing the radiation down to a spatial area on the sample near the diffraction limit. This form of Raman spectroscopy is referred to as Raman microscopy. The focused radiation produced when utilizing Raman microscopy forms a spot on the sample where the Raman spectroscopic analysis takes place.

In conjunction with Raman spectroscopy, spectral imaging may be used. Spectral imaging refers to the technique of producing images based on chemical contrast that contains spectroscopic data at each pixel of the image. Spectral imaging includes hyperspectral imaging. Hyperspectral imaging refers to a minimum of 100 spectral images containing spectroscopic information, whereas spectral imaging includes any number of images produced that contain spectroscopic information. A pixel is defined as the element of the detector that collects and records the radiation on a particular area of the camera used for acquisition of the Raman data. A typical Raman camera is comprised of numerous individual pixels that are arranged in a two dimensional format. Exemplary of using spectral imaging with Raman spectroscopy includes Raman microscopy and spectral imaging. In so doing, the radiation spot produced when utilizing Raman microscopy can be rastered across the sample in a controlled manner to produce spatially resolved point maps of the chemical components present in the sample. This form of spectral imaging for Raman microscopy is referred to as point mapping.

An additional form of Raman spectral imaging includes line mapping. Line mapping is a form of Raman microscopy where the radiation is projected onto the sample in the shape of a line. This line is rastered across the sample to produce spatially resolved line maps of the chemical components present in the sample.

A further example of Raman spectral imaging is referred to as global imaging. In this form of Raman spectral imaging, large fields of view are acquired by simply mapping the enlarged radiation spot across the sample. The enlarged radiation spot is produced by defocusing the radiation beam and results in global illumination of the sample. This technology represents the perfect compliment of quality spectroscopic information as well as detailed spatial information about the chemical distributions in a given sample. As a result, a traditional microscopic image can be acquired that contains the chemical spectroscopic information at each image point.

Moreover in respect to any Raman microscope the following applies. Typically, a laser will emit a laser beam of a chosen wavelength (monochromatic) and polarization that is directed through an optical microscope containing a microscope objective that directs the radiation onto the sample. The electric field of the radiation creates an induced dipole in the molecules of the sample. The induced dipole oscillates in time and will re-emit the radiation in all directions at all frequency components. The radiation emitted (scattered) from the molecule that is of the same frequency as the incoming light is called Rayleigh scatter. Scattered radiation that is of a different frequency from the incoming radiation is referred to as Raman scatter. The Rayleigh and Raman scatter will be collected along the same optical axis as the excitation (referred to as the epi-illumination configuration). The light will be directed into the spectroscopic interface that will then direct the scatter into a spectrometer. A filter will be in place to remove the Rayleigh light from the Raman scatter. Removal of the Rayleigh component is essential to monitor the Raman scatter. Once removed, the Raman scatter (composed of radiation of many frequencies higher and lower than the excitation frequency) will be directed onto a grating that will disperse the light into individual frequencies. Once dispersed, the light illuminates a detector where the intensity of the radiation at a given frequency can be acquired and displayed as a spectrum. The analysis of the intensity and shape of the spectral bands are directly related to the vibration of the molecule that changed the polarizibility tensor of the molecule analyzed. Commercially available apparatus for performing Raman spectroscopy includes the InVia™ Raman microscope available from Renishaw, Incorporated.

Mid-infrared spectroscopy is a non-destructive analytical technique in which the absorption, emission or reflection of light is measured in the 4000 to 200 cm⁻¹ (2.5 to 50 μm) region. Spectroscopic changes observed in this region are associated with transitions in vibrational energy states. For a transition to occur, the molecule (or crystal lattice) must undergo a net change in dipole moment. This requirement for infrared activity is known as a selection rule and is complimentary to the selection rule for the Raman effect.

Infrared spectroscopy can provide qualitative and quantitative chemical information about chemical identity and concentration. Infrared spectra can be obtained for samples in the solid, liquid, gas, or supercritical fluid phase. The technique is commonly used to investigate organic compounds, and occasionally inorganic compounds. It can also provide physical information about crystallinity, conformation, orientation of functional groups, hydrogen bonding, solvation effects, complex states, and ring strain.

Infrared spectroscopy can be used to investigate time-dependent and temperature-dependent phenomena such as phase transitions and chemical kinetics. Variable angle attenuated total reflectance infrared spectroscopy can be used to determine depth profiles (depth of penetration) of chemical composition in a heterogeneous sample. The technique can be used to investigate ultra-thin films assembled on dielectric and metal sub rates. In some cases sub-monolayer sensitivity can be realized.

Infrared spectra are most commonly collected using a Fourier transform infrared (FTIR) spectrometer, which employees some type of interferometer. Spectra are less commonly collected using a dispersive infrared spectrometer, which employs some type of grating or prism monochromator. Both types of instruments can be operated in a macroscopic or microscopic configuration. In the macroscopic configuration, the focal point of the infrared beam is usually about 1 cm in diameter at the sample position. In the microscopic configuration, the focal point of the infrared beam at the sample position can be reduced to the frequency dependent diffraction limit, for example approximately 12 μm at 1000 cm⁻¹. Bulk measurements are typically made in a macroscopic configuration, while spatially dependent measurements are typically made in a microscopic configuration.

Point and focal plane array (FPA) detectors are both used in macroscopic and microscopic configurations. Point detectors are used to obtain spectra that correspond to a single spatially averaged spot on the sample. The spot size can be very large (tens of centimeters) or very small (as small as the diffraction limit, e.g. ˜12 μm at 1000 cm⁻¹). FPA detectors can be used to obtain spatially resolved spectra in the form of line images or global images. Commercially available apparatus for performing mid-infrared spectroscopy (FTIR spectrometers and microscopes) includes the FTS7000m infrared interferometer and the UMA 600™ Fourier transform infrared microscope systems available from Digilab, Incorporated.

Near Infrared Spectroscopy (NIRS) is a well-established analytical tool for the quantitative measurement of organic compounds. By recording the pattern of light absorption (i.e. the absorption spectrum) in the wavelength region between 770 nm and 2500 nm (approximately 10¹⁴ Hz), the amount and type of chemical bonds present in an unknown sample can be empirically determined. This region of the electromagnetic spectrum is useful for quantitative measurements due to the availability of inexpensive, robust hardware for the creation, manipulation, and detection of photons at these wavelengths. The hardware advantage is augmented by the presence of significant photon absorptions within the vibrations of chemical bonds formed from all commonly occurring organic elements, including Hydrogen, Carbon, Nitrogen, Oxygen, and Sulfur. The fundamental or strongest vibrational absorptions for these bonds occur farther into the infrared portion of the electromagnetic spectrum (called the mid-IR region); NIRS spectra are actually comprised of frequency overtones and overtone combinations of these absorptions. As such, the absorption patterns in NIRS spectra are often too complex to allow for the interpretation of specific chemical identities. However, those patterns are recorded with such accuracy and precision that the patterns can be used to empirically determine the amount of various compounds within a mixture, provided an appropriate reference is known. Furthermore, the hardware necessary to measure those fundamental absorptions in the mid-IR region is more complex and fragile than NIRS hardware, and the extreme sensitivity to water of that hardware as well as the overwhelming impact that absorption by water has on mid-IR spectral features makes NIRS a much more practical tool. Thus, the most common NIRS applications occur in the natural products, petroleum, and pharmaceutical industries, where NIRS is used for quality assurance and composition monitoring.

Because NIRS techniques employ most of the same hardware used to conduct measurements in the visible region of the electromagnetic spectrum, very little modification is needed to perform NIRS in an imaging format as opposed to a bulk measurement format. The specific minerals used to manufacture NIRS optical elements and imaging detectors are different than those used for visible wavelength applications, but the minerals have the same practical advantages with respect to ease of use, durability, and interchangeability within existing visible wavelength instrumentation. A conventional microscope can be used to house the light source, optics, and detector for creating NIRS images of organic chemical composition on a microscopic scale. As with visible light imaging, NIRS can also be used in a macroscopic format to create true-size images of samples; all that is required is a light source that is usually a simple tungsten bulb, just as with standard visible wavelength applications, a wavelength filter, and an imaging detector composed of a two-dimensional array of individual detector elements.

NIRS imaging, either microscopic or macroscopic, is done in transmission mode or in diffuse reflectance mode. NIRS transmission images are captured in the same manner as a visible light transmission image: the light source is collimated to fill the field of view of the detector with the wavelength filter between the source and detector, a reference image is taken with no sample in place, then a thin, flat sample is placed in front of the light source either before or after the wavelength filter and parallel to the plane of the detector array. When the filtered images of the sample collected at the desired wavelengths are ratioed to the set of reference images taken at the same wavelengths, the resultant images consist of NIRS absorption spectra at each pixel in the detector array. NIRS diffuse reflectance images use the same hardware arranged in a different way: the light source is now used to light a thick, flat sample from the front, and light is collected that has diffused through the sample a small distance before being scattered back away from the sample surface into the detector. This technique also requires a set of reference images; these are usually formed by reflecting the light source off of a flat piece of ceramic, which has no significant absorptions in the NIRS wavelength region. When imaging on a macroscopic scale, multiple light sources are arrayed in a ring around the sample at an angle relative to the horizontal plane of the sample or the sun on a relatively clear day is used for environmental imaging. For microscopic imaging, the source must be directed onto the sample by the same optics that are used to collect the diffusely reflected light returning from the sample due to the small acceptance apertures of microscope objectives. A commercially available apparatus for performing NIRS diffuse reflectance imaging is the MatrixNIR™ available from Spectral Dimensions, Inc.

Ultraviolet visible spectroscopy is a ubiquitous analytical technique that relies on the interaction of optical energy with the electronic structure of molecular and atomic species. The specific absorption of light in the ultraviolet and visible range of the electromagnetic spectrum, wavelength range between 180-770 nanometers (nm), is due to the promotion of electrons in the bonding and non-bonding orbitals to excited states. The promotion of the electron, due to absorption of incident light, results in light intensity loss at the specific energy corresponding to the energy difference between the ground and excited states of the electron. Therefore, the structure observed in visible absorption spectra is due to the complex electronic structure of the sample under study. The bonding and non-bonding electronic structure of organic and inorganic species determines the shapes and positions of features in the spectra, and therefore qualitative assessment of unknown species may be made from spectral data. Likewise, the magnitude of the light energy loss due to absorption is, in general, directly proportional to the number of molecules or moieties present in the path of the light beam. From this relationship, quantitative assessments of the concentration and distribution of the chemical species of interest may be made from appropriately designed experimental apparatus. In addition, changes in chemical structure may be deduced from differences in the absorption spectral data observed during and after perturbation of a system under study. As an example, a pH change in solution causes the protonation of an organic acid molecule and a corresponding change in the shape of the absorption spectrum due to the change in the electronic structure of the molecule. The change is diagnostic as well as quantitative.

The interaction of light with matter is a complex phenomenon that is not restricted to absorption alone. Reflection, refraction, scattering, and coherence effects affect the interaction of light with the matrix of interest, and these effects may produce structures in the resulting spectral data that appear to be absorptive in nature. For example, the scattering of light from small, regular particles in a transmission measurement may attenuate the incident light in a wavelength dependent manner, producing structure in the spectral data that is indicative of absorption events. Likewise, the presence of periodic structures on the surface of a sample under interrogation may produce constructive or destructive interference that results in anomalous features in the absorption spectral data. Instrumental design and engineering, as well as sampling geometry and sample preparation, are employed to mitigate, or in some cases, take advantage of, optical effects that are convoluted with absorption events in a particular sample.

Ultraviolet visible spectroscopy is generally performed in liquid phase systems using standardized sampling configurations with fixed path length cells to allow for quantitation and calibration. The instrumentation is generally comprised of a stabilized light source or light sources of ultraviolet and visible character, such as deuterium and/or tungsten halogen, that is directed via either optical fibers or reflective optics through a sample compartment and can be either a single beam or dual beam configuration. The sample is generally held in an optically transparent cuvette. The interaction of light with the sample occurs in the cuvette and the light is collected via appropriate optical components and transferred to the dispersive element. In many cases, the light is dispersed via a diffraction grating and imaged onto a multi-element detector, like a charge coupled device (CCD) or photodiode array system. In some cases, the light is dispersed via a mechanically scanned grating onto a single element detector.

The detection system utilized in a standard transmission absorption measurement may be applied to other sampling modalities as well. Optical fiber interfaces have been developed for remote transmission, reflection, transflectance, attenuated total reflectance, and diffuse reflectance sampling geometries in order to take advantage of easy sample presentations and minimal sample preparation. These fiber optic interfaces are, in general, developed to minimize optical losses at the interfaces and provide high throughput to and from the sample. A commercially available apparatus for performing UV-Visible spectroscopy is the 8453E UV-Visible spectroscopy system available from Agilent Technologies Incorporated. An additional commercially available apparatus for performing UV-Visible spectroscopy is the Tidas UV-Visible spectroscopy system available from J&M Incorporated.

The application of ultraviolet visible absorption spectroscopy may be achieved in an imaging format as well, using appropriate instrumentation. Spectral imaging refers to the collection of images of a scene under different wavelengths of either interrogating or interacting light. An imaging system is generally comprised of a two-dimensional array of light sensitive pixels forming a camera and a wavelength selective element with the ability to disperse the incoming light into the component wavelength without disrupting the two dimensional integrity of the image. The wavelength selector may be a series of filters that are sequentially placed in front of the camera, or an interferometric sensor that forms a pattern on the detector that may be deconvoluted with appropriate mathematical treatment.

The purpose of such a system is the collection of an ultraviolet visible spectrum from a field of view or a scene at every pixel representing the scene. This image, if collected at a high enough spectral resolution (100 images or more) is referred to as a hyperspectral image. Analysis of the image spectral data reveals chemical composition data at every pixel, much like performing a separate bulk absorption experiment at every pixel. The information content of such a dataset is high and therefore amenable to multivariate data analysis, where small variations in intensity and spectral line shape are determined and used for quantitation and investigation. An example of such a universal ultraviolet visible hyperspectral imaging system is the Spectracube™ UV/Visible imaging system, manufactured by Applied Spectral Imaging, Inc.

Luminescence spectroscopy involves measuring the emission of light, from a chemical species, that occurs following absorption of light by that species. This absorption can span a wavelength range from the deep ultraviolet to the near infrared (approximately 180 nm to 1000 nm), and therefore involves electronic molecular transitions. These transitions occur between particular vibrational levels of the singlet ground and singlet or triplet excited electronic states. Luminescence occurs from the excited electronic state after vibrational relaxation within this state. This emission is characterized as fluorescence if the excited state is a singlet, and phosphorescence in the case of a triplet excited state. Phosphorescence is a rare event compared to fluorescence; therefore, fluorescence is far more widely used for routine analyses.

Chemical species exhibiting useful fluorescence are usually aromatic in nature; that is, the species contain conjugated networks of delocalized pi electrons. For example, the amino acids phenylalanine, tyrosine, and tryptophan contain aromatic benzene or pyrrole structures. These amino acids are included in many proteins found in food.

Fluorescence spectroscopy can be applied to non-luminescent species by tagging, or labeling, those species with a natively luminescent compound. Often, the tag is a derivative of an intensely fluorescent dye, like fluorescein. Such tagging often involves forming a chemical bond between the analyte and the fluorophore, and the specificity of the labeling is determined by its chemistry. In other cases, tagging is accomplished by preferential solubility of the fluorophore in the analyte compared to other species in the sample. For instance, a fat-soluble fluorescent dye can provide good selectivity for lipid in the presence of carbohydrate.

Fluorescence measurements take many forms. Commonly, one collects emission spectra at a single excitation wavelength, and excitation spectra while monitoring a single emission wavelength. This combination of excitation and emission spectra is often unique for a particular fluorophore, imparting good selectivity to fluorescence spectroscopy. Furthermore, since the quantum yields of typical fluorophores are often large, limits of detection are often in the parts-per-billion range. An instrument called a fluorimeter is designed to collect both excitation and emission spectra from samples in solid or liquid form. A fluorimeter uses an arc lamp, usually Xenon, to irradiate the sample, and spectrally disperses and measures the resulting fluorescence. The sample may be in the free optical path of the instrument, or optical fibers can be used to direct excitation light to a remote sample, and then bring emission from that sample back to the fluorimeter. These optical fiber probes can be used not only for bulk sampling, but also for coupling a microscope to a fluorimeter. This combination allows collecting excitation and emission spectra from objects, like biological cells, in a microscopic field. Horiba (JY-Spex) makes a commercially available fluorimeter, the Fluoromax 3™, which accepts optical fiber accessories of the type described above.

A more traditional use of fluorescence microscopy is as an image contrast aid rather than for collecting spectral information. When imaging a particular fluorophore, the microscope's illuminator is fitted with a filter isolating light appropriate for fluorophore excitation. The microscope's observation path is fitted with another filter, which isolates the fluorescence. The dual wavelength parameter and the sensitivity of fluorescence give fluorescent labeling advantages over simple color staining for image contrast.

For even better sensitivity and spatial resolution, a microscope can be fitted with a confocal laser scanning accessory. In this case, a laser provides intense and highly-focused excitation, and the confocal nature of the emission collection allows very fine depth resolution within a sample. A highly-resolved three-dimensional picture of the sample can be created by assembling a number of confocal image cross-sections. Nikon makes a commercially-available C1™ confocal laser scanning microscope.

Fluorescence imaging can be on a macro scale as well as a micro scale. Optics can be used to evenly illuminate samples of various sizes, and digital cameras can be used with filters to produce high resolution images showing the distribution of individual fluorophores across a sample. When spectral, as well as spatial, resolution of the emission is desired within the image, the imaging camera can be attached to an imaging spectrometer.

Situations exist which require spectral and spatial discrimination in both the excitation and emission spaces—when trying to distinguish among several fluorophores in a complex sample matrix, for example. In these cases, the spectrally-dispersed excitation source is imaged onto the sample in one dimension, and the resulting fluorescence is dispersed and imaged in an orthogonal dimension onto a digital camera. The resulting digital image is a structure known as an excitation-emission matrix (EEM), which contains the total fluorescence from the analytes in the sample. A collection of these EEM's at varying analyte concentration forms a hyperspectral data cube, the deconvolution of which provides the spectra of each fluorescent component in the mixture. Horiba (JY-Spex) makes a commercially-available Spex 3D™ EEM instrument.

A further dimension to the spectral information provided in a fluorescence measurement is the fluorescence lifetime. After excitation, the fluorophore's electronic excited state decays by emission. This decay has a definite lifetime depending on the nature of the fluorophore, and can be used, therefore, as a means of distinguishing two species with similar spectral properties. Fluorescence lifetimes are usually on the order of ten nanoseconds, so measuring the lifetimes requires pulsed excitation sources and time-gated detectors. Horiba (JY-Spex) makes a Tau Lifetime™ instrument that is capable of measuring fluorescence lifetimes.

The apparatus of the present invention is produced utilizing any technology known for combining two or more items of equipment to form an integral unit. For example, any mechanical technique utilizable for uniting two or more mechanical components to provide a single piece of apparatus is suitable for use. Therefore, it is apparent that there is nothing critical regarding the manner of combining an automated polarized light microscope together with any means for achieving spectroscopic analysis that may also include the use of a microscope.

Utilization of the present invention related to an apparatus comprising an automated polarized light microscope combined with means for achieving spectroscopic analysis that may include a microscope results in expectation of the following advantages. As noted above, the means for achieving spectroscopic analysis may include means for spectral imaging.

1) Same Sample Region can be Observed and Analyzed by Both Techniques.

Currently, to perform analysis with automated polarized light microscopy and any spectroscopic means, a sample would have to be transferred from one instrument to the other for analysis. By having these techniques combined into one platform, more detailed chemical and structural information can be acquired for a given sample region providing more insight into the sample. In addition, the conclusions derived from each technique can be confirmed and validated by the other technique for the same sample region analyzed.

2) Quick View of Key Areas of Interest in a Given Sample.

Most spectroscopic based microscopes employ a visible camera instead of a binocular attachment to view a sample in bright field that is white light illumination either in transmission or reflection. The automated polarized light microscope would serve as an additional mode for viewing the sample while providing information regarding key areas where chemical or structural differences may reside based on the retardance data for the image. Traditional bright field images have poor contrast and do not provide any structural information that could aid in the subsequent spectroscopic analysis. The images essentially provide a picture of the sample. By having an automated polarized light microscope showing both the magnitude of the retardation and the birefringence axis at each point in the image, the spectroscopic analysis can be performed quicker since the experimenter can go directly to the region of interest in the field of view that looks most interesting and is most promising for obtaining important spectral information. An automated polarized light microscope image provides a snapshot of chemical and structural differences in a sample prior to any spectroscopic analysis. This apparatus provides a rapid and efficient form of microscope based spectroscopic analysis. This apparatus improves upon an existing limitation of spectroscopic analysis that includes the use of a microscope.

3) Fast Identification.

The automated polarized light microscope provides data about the molecular order or crystallinity of a given sample, but does not have the ability to identify the chemical composition of the sample. By coupling an automated polarized light microscope to a means for performing spectroscopic analysis, maps of structural order based on the birefringence of the material can be obtained as well as detailed chemical identification of the sample. This apparatus improves upon an existing limitation of the technology that governs an automated polarized light microscope.

4) Differentiation between Physical and Chemical Properties of a Given Sample.

This apparatus provides an easy way to determine if a change in the retardance values calculated in the polarized light image are due to chemical changes occurring in the material or simply physical changes in structural order. This advantage is only possible because spectroscopic analysis has the ability to differentiate chemical differences if present. In other words, if two chemical components in an automated PLM image are observed to have different amounts of microscopic order, the researcher can analyze these two chemical components spectroscopically to see if these differences are due to physical or chemical changes in the system.

5) Ease in Identification of Subtle Spectroscopic Trends.

Small changes in molecular order will be readily apparent in an automated polarized light microscope image. The automated polarized light microscope portion of this apparatus is extremely sensitive to small changes in the structural properties of chemical species. Without the automated polarized light microscope information, these small structural changes are not easily identified spectroscopically due to the fact that these changes are often manifested as slight band broadening or shifts. To obtain this information spectroscopically, calculations of bandwidths or frequency positions must be performed. Because the spectral changes may be small, the validity of these small changes is often questioned. Through the use of this apparatus, two independent sources of data are provided that observe the same structural changes in the sample thereby validating the effect observed by a single analysis technique.

6) Multiple Sources of Data can be Correlated Against Each Other.

The automated polarized light microscope provides numerical retardance values and slow axis orientation information for each spatial position per individual pixel on a given sample. Any statistical values for a given pixel related to birefringence can be correlated to the spectral information provided in the same pixel for quantitative analysis. Improved regression models, for example Partial Least Squares and Multivariate Curve Resolution, can be constructed to compare and correlate the automated polarized light microscope results to the spectroscopic data. This is an option not easily obtainable by the traditional cross polarizers apparatus and represents an advantage of this present apparatus. More specifically, quantitative spectral imaging currently is not developed. At the present time, quantitative algorithms used for quantitative spectral imaging analysis suffer from not having an independent source of data related to concentration. This apparatus overcomes this limitation by providing two independent sources of data for each pixel in the image.

The following example is presented to illustrate the present invention and to assist one of ordinary skill in making and using the same. The example is not intended in any way to otherwise limit the scope of the invention.

### EXAMPLE 1

Samples of individual nylon and polyester fibers were analyzed in the following manner. An individual fiber of nylon and an individual fiber of polyester were placed onto a microscope slide and brought close together spatially so that sections of both fibers were able to be viewed utilizing a 20× objective on a standard microscope in transmission mode. The fibers were approximately the same size in diameter and were indistinguishable utilizing transmission mode bright field viewing.

In carrying out the analysis utilizing both automated polarized light microscopy and Raman microscopy, the two individual techniques had to be coupled onto the same microscope so that the same sample and the same sample regions could be analyzed by both techniques. To perform this, certain individual parts of the commercially available LC-PolScope IM Automated Polarized Light Microscope were incorporated onto the Falcon Raman global imaging system. The individual parts utilized from the LC-Polscope IM Automated Polarized Light Microscope were the image acquisition device (camera), the LC retarders, and the narrow bandpass filter (546 nm) and circular polarizer. The filter and circular polarizer were placed in series onto the lens of the transmission light optic beneath the condenser on the Olympus BX-60 microscope utilized in the Falcon Raman global imaging system. The LC variable retarders were placed above the spectroscopy interface housing on the Falcon Raman global imaging system. The camera and optical tube used as the acquisition device for the polarized images were mounted onto the port where the bright field camera resides on the Falcon Raman global imaging system, thus replacing this bright field camera. The LC variable retarders resided in between the spectroscopy interface and optical tube leading to the acquisition device (camera). Prior to collection of data, the fields of view for the camera utilized to acquire the polarized images and the camera utilized to collect the Raman global images were aligned so that the same area of a standard resolution target was imaged. This alignment ensures that both cameras are viewing the same region for a given sample. No software incorporation was performed to utilize this invention. The software controlling the Raman system and the software controlling the automated polarized light microscopy system were utilized on separate computers.

The analysis of the nylon and polyester fibers involved collecting bright field images with the software that controlled the automated polarized light microscopy system. The images were collected in transmission mode with a 20× objective. After collection of the bright field images, which is optional and not required for performing automated polarized light microscopy, the 546 nm bandpass filter and polarizer were put into place and the polarized images with calculated retardance values were collected for the nylon-polyester sample matrix.

To perform the Raman analysis, the turret of the spectroscopy interface was rotated to allow the laser beam and Raman scatter to travel to and from the sample and back into the Raman imaging detector (camera). The excitation radiation of the Falcon Raman global imaging system is a 532 nm Nd:Yag laser line. The same fiber sample as stated above was subjected to Raman global imaging. The data was recorded and analyzed for the sample region of the fiber sample. For semi-point analysis, a given section of the same region of the sample was brought into focus using a 100× objective to minimize the global radiation spot on the sample. This approach produces a much smaller radiation spot on the sample allowing smaller regions to be analyzed. The average spectrum of this smaller region was collected. Due to the defocusing of the laser beam in the Falcon Raman global imaging system, true point analysis cannot be performed.

The end result of this combined approach was a polarized light image with retardance values per pixel that identified quickly that the fibers were different. In other words, the automated polarized light microscopy analysis for this sample provided contrast differences for the two fibers based on retardance values suggesting regions where the samples were compositionally different. Once these regions were identified, the Raman analysis was performed identifying certain fibers in the field of view as nylon and polyester. Therefore, the automated polarized light microscopy provided the key areas of the sample to probe while the Raman analysis provided the compositional differences of this sample region.

The invention has been described to reference to various specific and illustrative embodiments and techniques. However, one skill in the art will recognize that many variations and modifications may be made while remaining within the spirit and scope of the invention.

What is claimed is:

1. An apparatus comprising an automated polarized light microscope combined with spectroscopic means.

2. The apparatus according to claim 1 wherein the spectroscopic means are utilized in accordance with at least one Raman spectroscopic technique.

3. The apparatus according to claim 2 wherein the at least one Raman spectroscopic technique comprises using a microscope.

4. The apparatus according to claim 1 wherein the spectroscopic means are utilized in accordance with at least one mid-infrared spectroscopic technique.

5. The apparatus according to claim 4 wherein the at least one mid-infrared spectroscopic technique comprises using a microscope.

6. The apparatus according to claim 4 wherein the at least one mid-infrared spectroscopic technique utilizes interferometric data acquisition.

7. The apparatus according to claim 1 wherein the spectroscopic means are utilized in accordance with at least one near-infrared spectroscopic technique.

8. The apparatus according to claim 7 wherein the at least one near-infrared spectroscopic technique comprises using a microscope.

9. The apparatus according to claim 1 wherein the spectroscopic means are utilized in accordance with at least one ultraviolet spectroscopic technique.

10. The apparatus according to claim 9 wherein the at least one ultraviolet spectroscopic technique comprises using a microscope.

11. The apparatus according to claim 1 wherein the spectroscopic means are utilized in accordance with at least one visible spectroscopic technique.

12. The apparatus according to claim 11 wherein the at least one visible spectroscopic technique comprises using a microscope.

13. The apparatus according to claim 1 wherein the spectroscopic means are utilized in accordance with at least one luminescence spectroscopic technique.

14. The apparatus according to claim 13 wherein the at least one luminescence spectroscopic technique comprises uses a microscope.

15. An apparatus comprising an automated polarized light microscope combined with spectroscopic means having means for spectral imaging.

16. The apparatus according to claim 15 wherein the spectroscopic means are utilized in accordance with at least one Raman spectroscopic technique.

17. The apparatus according to claim 16 wherein the at least one Raman spectroscopic technique comprises using a microscope.

18. The apparatus according to claim 15 wherein the spectroscopic means are utilized in accordance with at least one mid-infrared spectroscopic technique.

19. The apparatus according to claim 18 wherein the at least one mid-infrared spectroscopic technique comprises using a microscope.

20. The apparatus according to claim 15 wherein the spectroscopic means are utilized in accordance with at least one near-infrared spectroscopic technique.

21. The apparatus according to claim 20 wherein the at least one near-infrared technique comprises using a microscope.

22. The apparatus according to claim 15 wherein the spectroscopic means are utilized in accordance with at least one ultraviolet spectroscopic technique.

23. The apparatus according to claim 22 wherein the at least one ultraviolet spectroscopic technique comprises using a microscope.

24. The apparatus according to claim 15 wherein the spectroscopic means are utilized in accordance with at least one visible spectroscopic technique.

25. The apparatus according to claim 24 wherein the at least one visible spectroscopic technique comprises using a microscope.

26. The apparatus according to claim 15 wherein the spectroscopic means are utilized in accordance with at least one luminescence spectroscopic technique.

27. The apparatus according to claim 26 wherein the at least one luminescence spectroscopic technique comprises using a microscope.

28. The apparatus according to claim 1 wherein the spectroscopic means are utilized in accordance with a Raman spectroscopic technique, wherein the Raman spectroscopic technique comprises using a microscope, and further wherein the Raman spectroscopic technique has means for spectral imaging.
